(19) United States
(12) Patent Application Publication
(10) Pub. No.: US 2015/0106429 A1
(43) Pub. Date: Apr. 16, 2015

(54) METHOD AND SYSTEM OF COMPILING AND SHARING EMOTIVE SCORING DATA

(71) Applicant: UrVibe LLC, Arlington Heights, IL (US)

(72) Inventors: Thomas Hegberg, Arlington Heights, IL (US); John Fillipitch, Minneapolis, MN (US)

(73) Assignee: UrVibe LLC, Arlington Heights, IL (US)

(21) Appl. No.: 14/054,160

(22) Filed: Oct. 15, 2013

(51) Int. Cl. H04L 29/06; H04L 29/08

(52) U.S. Cl. CPC H04L 67/42; H04L 67/22
USPC 709/203

(57) ABSTRACT

A method and system for compiling scoring data from users based on their feelings relating to an area of common interest of computing devices is disclosed. A tile relating to an area of common interest is associated with a user. The tile with a current score is displayed to the user. An updated score is requested from the user relating to their feeling associated with the area of common interest. An updated score from the user associated with the area of common interest is received. Scores from other users are displayed to the user when the updated score is received.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present invention relates generally to a score tracking application, and more particularly, to a score tracking application to encourage the entry of user scores based on their feelings on topics of common interest to provide trend data for other application users.

### BACKGROUND

Social networking using the Internet has provided new opportunities for people to establish relationships and learn about current status and data about each other. Various interests in different areas rely on popularity for subjective factors such as feelings or reactions by users who may make such data available to other users such as friends or followers. Such information may be of interest to others who have interest in each other or any subject. Such information may be used to establish connections with mobile users and serve as a barometer of what is trending and popular. Unfortunately, no currently known application or website provides a social platform to share feelings about subject matter to friends or acquaintances in a meaningful way. Further no social network application has any incentive for a person to record their feelings at a particular time.

There is a natural need to know how friends feel about certain common interests or even of other people. For example, many are interested in staying in touch with close friends in a deeper, meaningful way and want to know how their close friends are feeling. There are also users that are interested in determining feelings of others on common interests in such a way to know what interests are trending or have the interest of others.

People are competitive to feel the best or even the worst. Current social media such as Twitter®, YELP®. Facebook® or other popular applications provide some commentary, but such commentary is often devoid of emotional depth and intelligence. For example, certain media such as Facebook provide a disincentive to post feelings about subject. For example, users feel like they do not have a true personal connection with many users, or simply watch and do not offer a posting on what they feel. There is no mechanism to compel users to post ratings about themselves or common interests in existing social media as it depends on a user offering such feelings in a posting. Thus, a means where ratings reflecting emotional depth and desires across structured categories does not exist.

Thus, there is a need for an application that compels users to enter a score associated with their feelings regarding certain interests in a structured manner. There is a further need for an application that provides a safe, secure environment to post and broadcast how a user feels about certain subject matters of interest. There is a further need for an application that allows a user to check in on friends and see how they are feeling as well as scores related to overall feeling for various groups organized around common interests.

### SUMMARY

According to one example, a method of compiling scoring data from users of computing devices in communication with a central server is disclosed. A tile relating to an area of common interest is associated to a user. The tile with a current score is displayed to the user on a display of a user device. An updated score is requested from the user based on the user's feelings relating to the area of common interest. An updated score from the user associated with the area of common interest is received. Scores from other users are displayed when the updated score is received.

Another example is a system for collecting and disseminating scores from users associated with devices in communication with a central server. The system includes a database including user information and associated tiles with each user. Each tile is associated with an area of common interest. A communications interface broadcasts scores with associated tiles to user devices. A controller is operable to receive requests to access a user account and request a user to enter a score for at least one tile associated with an area of common interest. The score relates to the user's feeling about the area of common interest. The controller is operable to receive the score from the user and send information allowing the display of scores relating to a plurality of tiles, each relating to an area of common interest, for display on a user device.

Another example is a device for participating in viewing data relating to user emotions. The device includes a display and a communication interface to receive data from a central database. The device also includes a controller operable to display scores relating to the feeling of a user associated with an area of common interest via a tile representing the area of common interest on the display. The controller is also operable to require a user to enter an updated score relating to the area of common interest and receive a score and allow the display of additional tiles relating to areas of common interest on the display.

Another example is a non-transitory, machine readable medium having stored thereon instructions for collecting and displaying user scores on areas of interest. The stored instructions comprise machine executable code, which when executed by at least one machine processor, causes the machine processor to store a score from a user device relating to an area of interest to a user, wherein the score is associated with the user's feeling relating to the area of interest. The code also causes the processor to request an updated score from the user of the user device on the area of interest and on receiving the updated score, send scores relating to other areas of interest associated with the user for display on the user device.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a block diagram of a system that may be used to run an application to collect and broadcast emotional score data from user devices;

FIG. 2 is a block diagram of an example mobile user device for a user that may participate in the collection of emotional score data by the system in FIG. 1;

FIG. 3 is a flow diagram showing the display of various screens in the application for user devices in FIG. 1;

FIG. 4A is an image of a main screen shown on a user device using the network application in FIG. 1;

FIG. 4B is an image of the main screen in FIG. 4A with a dropdown tile arrangement menu activated;

FIG. 4C is an image showing a main screen with an alternate tile arrangement when the “what's new” menu option is selected in FIG. 4B;

FIG. 4D is an image showing another main screen with an alternate tile arrangement when the “what's hot” menu option is selected in FIG. 4B;

FIG. 5A is an image of the group tile feed screen shown on a user device running the application in FIG. 1 where a user is a follower of a group tile;

FIG. 5B is an image of a group tile feed screen where the user is not a follower of a group tile;

FIG. 6A is an image of a user tile feed screen shown on a user device using the social scoring network application in FIG. 1, when the user is a follower of another user;

FIG. 6B is an image of a pop-up menu to rearrange displayed tiles on the follower feed screen in FIG. 6A;

FIG. 6C is an image of a user tile feed screen when a user is a friend of another user;

FIG. 6D is an image of a user tile feed screen displayed when the user is not a follower of another user;

FIG. 7A is an image of a user interface score tool screen shown on a user device to enter an emotional score to the system in FIG. 1;

FIG. 7B is an image of an add photo pop-up screen activated from the score tool screen in FIG. 7A;

FIG. 7C is an image of a tag group pop-up screen activated from the score tool screen in FIG. 7A;

FIG. 7D is an image of a share group pop-up screen activated from the score tool screen in FIG. 7A;

FIG. 8A is an image of a scoring tool screen for entering an emotional score for a posting relating to a group tile;

FIG. 8B is an image of an alternative scoring tool screen showing comments and images for entering a score for a group tile;

FIG. 9A is a search screen displayed for showing major categories of group tiles for searching in the application in FIG. 3;

FIG. 9B is a search screen displaying subcategories of group tiles from selecting one of the major categories in the search screen in FIG. 9B;

FIG. 9C is a search screen displayed from selecting a subcategory showing available tiles under the subcategory selected in FIG. 9B;

FIG. 9D is an invite friend/follower screen displayed to allow a user to invite other persons to join the application;

FIG. 9E is an option selection screen for a user to control various settings of the application; and

FIG. 10 is a flow diagram of the process used by the scoring data collection application operating on user devices in FIG. 1.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

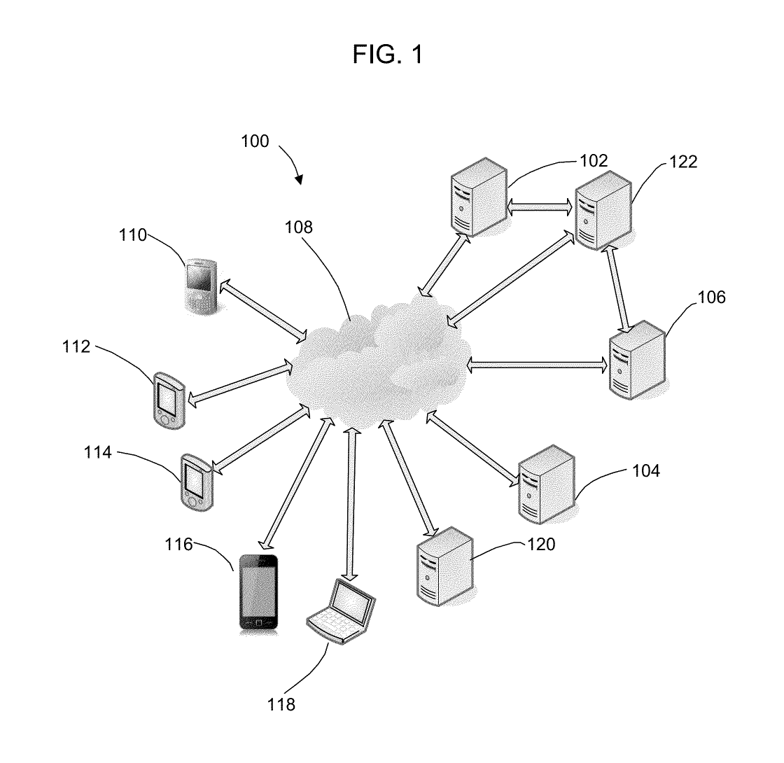

FIG. 1 shows a system 100 for the collection and broadcast of data relating to the feelings of users on various persons or subjects of user interest. The collection and broadcast of such emotional data may also reflect trending data for the user, other persons and subjects of common interest. The collection and broadcast of data is administered by a scoring application server 102 that is interfaced with a web server 104 and an application server 106. The web server 104 includes various applications that may be accessed to establish accounts and provide information to potential users for broadcasting and displaying emotion based scoring data on persons or subjects of interest to a user. The application server 106 organizes information in the form of tiles relating to persons or groups of interest that users are following and have entered their own ratings based on their emotions. The application server 106 also analyzes collected emotional scoring data for assigning overall scores and establishing trends for broadcast to applications run on user devices.

The server 102 communicates wirelessly through a network 108 to various user devices 110, 112, 114, 116, and 118 in this example. The user devices 110, 112, 114, 116, and 118 are accessible by users and run the application to collect and broadcast emotional scoring data. The servers 104 and 106 may be in direct communication with the server 102 or they may communicate through the network 108. It is to be understood that two or more computing systems or devices may be substituted for any one of the computing systems or devices in the system 100. Accordingly, principles and advantages of distributed processing, such as redundancy, replication, and the like, also can be implemented, as desired, to increase the robustness and performance of the devices and systems of the system 100.

In this example, certain user devices such as user devices 110, 112, 114, and 116 are generally portable or mobile devices that include geo-referencing hardware and software that allow their location to be known to both their users and the server 102. The geo-referencing hardware and software for locating a particular device in this example is based on the Global Positioning System (GPS), but other geo-referencing systems may be used. As will be explained, the users of the mobile devices 110, 112, 114 and 116, and computing device 118 may be members of a conventional social network application administered by a conventional social network server 120 and may share data with accounts on the social networks. An example of a conventional social network is FACEBOOK®, TWITTER® or YELP®.

The server 102 is also coupled to a database storage server 122. The database storage server 122 includes user information such as identification data relating to users of the application operated by the server 102. The database storage server 122 also includes data which relates to emotional scores entered by users in relation to associated persons or subjects displayed in the form of tiles on an interface screen on the user devices and tiles associated with each user. The database storage server 122 also includes other data such as trends compiled from submitted scores from users that are made available to other users of the system 100. As will be explained below, the database storage server 122 also stores data related to tiles which impart scoring data, comments and other current information relating to subjects of interest to the users. The application server 106 may be used to create, edit and post information via a communication interface with the network 108 on the tiles which are then displayed for the users of the application on computing devices such as the user devices 110, 112, 114, 116 and 118. The server 102 includes a controller that operates to receive requests to access a user account from a user device. The server 102 requests a user to enter a score for at least one tile associated with an area of common interest. As will be explained below, the score relates to the user's feeling about the area of common interest. The server 102 receives the score from the user and sends information allowing the display of scores relating to a plurality of other tiles, each relating to an area of common interest associated with the requesting user, for display on the user device.

The mobile user devices 110, 112, 114 and 116 may include virtually any preferably mobile computing device that is configured to send and receive information over a wireless capable network, such as the network 108. In this example, the user devices 110, 112, 114, 116, and 118 are web-enabled and may run browser software for the presentation of web pages to the user. Such mobile user devices 110, 112, 114, and 116 may include portable devices such as cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The user device 118 may be a lap top computer, a desk top computer, a work station or other computer. The user devices 110, 112, 114, 116 and 118 may include multiprocessor systems, microprocessor-based, or programmable consumer electronics, and the like. As such, user devices running the application described below may range widely in terms of capabilities and features.

As exampled below, the web-enabled user devices 110, 112, 114, 116, and 118 may include a browser application enabled to receive and to send wireless application protocol messages (WAP), and/or wired application messages, and the like. The user devices 110, 112, 114, 116, and 118 also include a social scoring application that may be run in conjunction with the browser application. In one example, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information.

The user devices 110, 112, 114, 116, and 118 may also include at least one client application that is configured to receive control data and/or content from another computing device via a network transmission. The client application may include a capability to provide and receive textual content, graphical content, video content, audio content, and the like. Moreover, the user devices 110, 112, 114, 116, and 118 may be further configured to communicate and/or receive a message, such as through a Short Message Service (SMS), direct messaging (e.g., Twitter), e-mail, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between or with another computing device, and the like.

The network 108 is configured to allow communications between one computing device and another computing device. The network 108 may be enabled to employ any form of computer readable media for communicating information from one electronic device to another. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines; full or fractional dedicated digital lines including T1, T2, T3, and T4; Integrated Services Digital Networks (ISDNs); Digital Subscriber Lines (DSLs); wireless links including satellite links; or other communication links known to those of ordinary skill in the art. Furthermore, remote computers and other related electronic devices can be remotely connected to either LANs or WANs via a modem and temporary telephone link.

The network 108 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The network 108 may also include an autonomous system of terminals, gateways, routers, and the like connected by wireless radio links or wireless transceivers. These connectors may be configured to move freely and randomly and organize themselves arbitrarily, such that the topology of the network 108 may change rapidly and arbitrarily.

The network 108 may further employ a plurality of access technologies including 2nd (2G), 2.5, 3rd (3G), 4th (4G) generation radio access for cellular systems; WLAN; Wireless Router (WR) mesh; and the like. Access technologies such as 2G, 3G, 4G, and future access networks may enable wide area coverage for mobile devices, such as the user devices 110, 112, 114, 116, and 118, with various degrees of mobility. For example, the network 108 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. The network 108 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, the network 108 may include virtually any wired and/or wireless communication mechanisms by which information may travel between one computing device and another computing device, network, and the like.

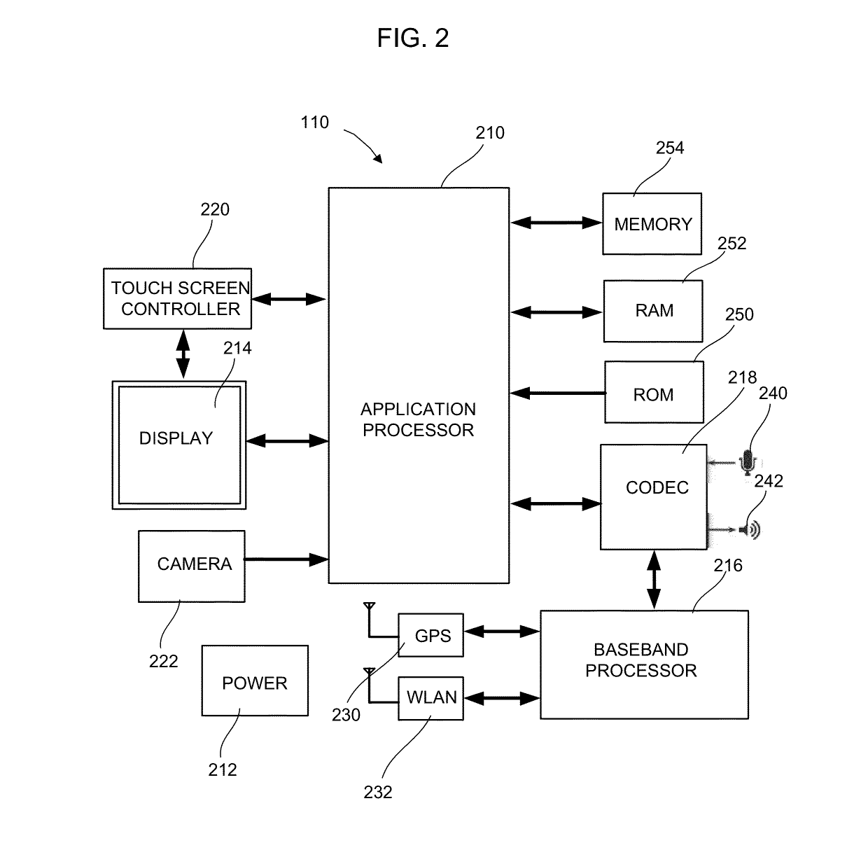

FIG. 2 is a block diagram of the components of a mobile user device such as the mobile user device 110 in FIG. 1. The mobile user device 110 includes an application processor 210, a power source 212, a display 214, a baseband processor 216, and a CODEC 218. In this example, the display 214 is an LCD touch screen that allows the user to control the applications run by the application processor 210 via touch inputs as well as to view graphics generated by the application processor 210. The display 214 is controlled by a touch screen controller 220. The application processor 210 may be coupled to various devices such as a camera 222 and other interfaces such as a communication port, etc.

The baseband processor 216 receives signals from a communication interface such as a network transmitter receiver 230 allowing communications with the network 108 in FIG. 1 and a geo-referencing receiver 232 that allows the reception of positioning data to determine the location of the mobile user device 110. The baseband processor 216 processes in the signals and is coupled to the CODEC 218, which converts the signals for use by the application processor 210. The CODEC 218 also decodes audio signals received by a microphone 240 and encodes data signals for output by a speaker 242 for functions such as a telephone application run by the applications processor 210. Of course other audio devices such as a headset may be coupled through the CODEC 218.

The processors 210 and 216 may be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA), and the like, programmed according to the teachings as described and illustrated herein, as will be appreciated by those skilled in the computer, software, and networking arts.

The operating system software and other applications are stored on read only memory (ROM) 250, random access memory (RAM) 252 and a memory storage device 254 for access by the applications processor 210. In this example, the memory storage device 254 is flash memory, but other memory devices may be used. The applications stored on the memory storage device 254 are instructions including machine executable code which when executed by a machine processor such as a controller cause the machine processor to perform application functions. One stored application includes the emotional score data collection and broadcast application, which creates interface graphics on the display of the user device. Of course other applications may incorporate the principles explained below. In this example, the social scoring application may be preloaded on the mobile user device 110, or may be offered as an application that may be downloaded to the mobile user device 110 from a network device such as the server 102 via the network 108.

The memory storage device 254 includes a non-transitory, machine-readable medium on which is stored one or more sets of instructions (e.g., software) embodying any one or more of the methodologies or functions described herein. The instructions may also reside, completely or at least partially, within memory storage device 254, the ROM 250, the RAM 252, and/or within the processors 210 or 216 during execution thereof by the mobile user device 110. The instructions may further be transmitted or received over a network such as the network 108 in FIG. 1A via the network transmitter receiver 230. While the machine-readable medium is shown in an example to be a single medium, the term “machine-readable medium” should be taken to include a single medium or multiple media (e.g., a centralized or distributed database, and/or associated caches and servers) that store the one or more sets of instructions. The term “machine-readable medium” can also be taken to include any medium that is capable of storing, encoding, or carrying a set of instructions for execution by the machine and that cause the machine to perform any one or more of the methodologies of the various embodiments, or that is capable of storing, encoding, or carrying data structures utilized by or associated with such a set of instructions. The term “machine-readable medium” can accordingly be taken to include, but not be limited to, solid-state memories, optical media, and magnetic media.

A variety of different types of memory storage devices, such as a random access memory (RAM) or a read only memory (ROM) in the system or a floppy disk, hard disk, CD ROM, DVD ROM, flash, or other computer readable medium that is read from and/or written to by a magnetic, optical, or other reading and/or writing system that is coupled to the processor, may be used for the memory or memories in the user device 110.

The application run on user devices communicating with the application server 102 such as the user devices 110, 112, 114, 116 and 118 in FIG. 1 allows users to enter emotional data (how they feel) about themselves, other persons or subjects (topics) of common interest. The application is executed on a controller such as the processors 210 or 216. As will be explained below the controller executes the application and is operable to display scores relating to the feeling of a user associated with an area of common interest via tiles representing areas of common interest. The application incentives users to enter emotional data by requiring a user to enter an updated score related to the area of common interest and then allowing a user to view information on how others feel about a certain interest when the user enters data on their own emotions. The updated score may also allow the display of additional tiles relating areas of common interest on the display of the user device.

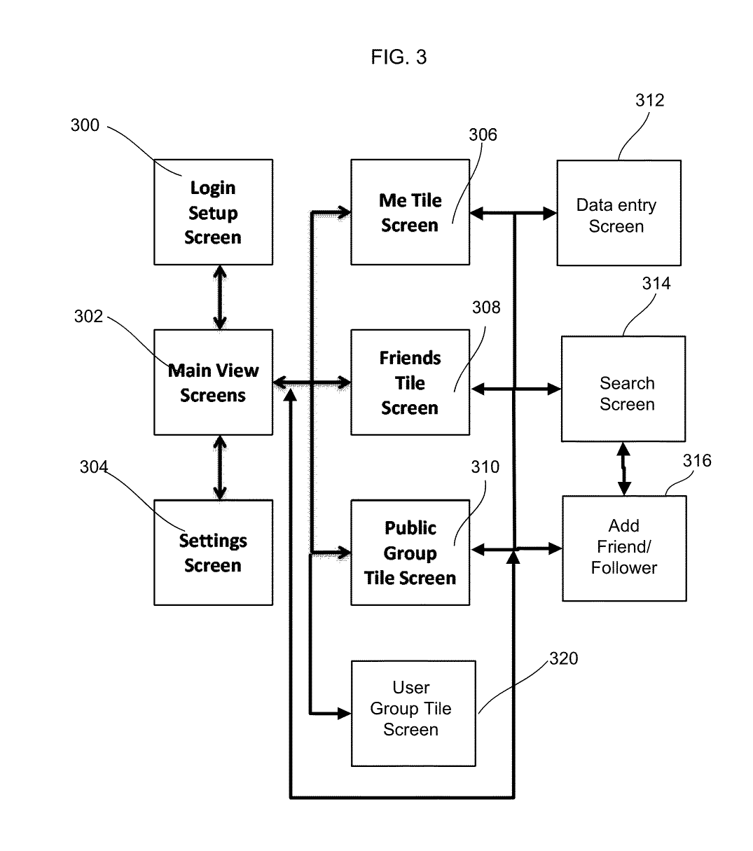

FIG. 3 is a tree diagram of the display of various information and input screens accessible by a user of the application running on a computing device such as the user devices 110, 112, 114, 116, and 118 in FIG. 1. The arrows indicate the ability to navigate between the information and input screens 300-320. A user is first shown a log in/set up screen 300. The log in/set up screen 300 allows the user to register an account and access stored information relating to the application account in the database storage server 122. The user is then directed to a main view or home screen 302. The main view screen or screens 302 allow a user to view different tiles relating to persons and subjects of interest to the user. The main view screens 302 allow a user to adjust the settings of the application by accessing a setting screen. As will be explained below, the main view screens 302 represent different views that a user may select that display tiles. The main view screens 302 also allow a user to access one of three tile information screens, a “me” tile information screen 306, a friends tile information screen 308 and a public group tile information screen 310. As will be explained below, the “me” tile information screen 306 relates to a tile associated with the user, the friends tile information screen 308 relates to tiles associated with other users who are friends of the user and the public group tile information screen 310 relates to tiles associated with subjects of common interest as will be explained below.

In this example, the public group tiles that are displayed in the public group tile information screen 310 are administered by the application server 106 and may be monitored for content by a system operator. The main screen 302 and the tile information screens 306, 308 and 310 allow a user to enter data (scores, comments, photos) relating to how a user feels about the respective tiles via a data entry screen 312. A search screen 314 may be accessed by main screen 302 and the tile information screens 306, 308 and 310 to allow a user to search for group tiles and user tiles. Once a user tile is found, the search screen 316 allows another user to be added as either a friend or a follower as explained below. An optional fourth type of tile may be made available in the form of a user group tile information screen 320. Similar to the tile information screens 306, 308 and 310, tile information may be displayed to the user on this screen. The user group tile is created by users of the application and may be controlled by the user or users to monitor and post content.

As will be explained below, the main view screens 302 are interfaces that allow a user to view trending data on tiles representing friends or subjects of common interest. The user enters emotional scoring data through the application on how the user is feeling about themselves, other persons and subjects of common interest. The scoring data entered by the user on themself and subjects of common interest allows the user to then access data relating to how others are feeling about common interests or themselves. In this manner, a user is provided an incentive to provide updated emotional scoring data on themselves and subjects of common interest.

As will be explained below, friend status between users of the application are established when both users acknowledge each other as friends. Friend status allows the sharing of additional information relating to other users and the ability to score and comment on each other as will be explained below. A user may also be a follower of another user or of a subject of common interest. A follower does not require mutual authorization from the user that is followed, but is limited in the type of information available to the follower in relation to a person as will be explained below. For example, a follower cannot make comments relating to the user they are following. In this example, individual user tiles may only be viewed by users with friend status and therefore eliminate the follower status. Alternatively, the application may allow both friends and followers of an individual user. The user may also be provided with a control option that allows the user to not accept followers for individual user tiles. A user can always become a follower of a group tile relating to a subject of common interest.

The dynamic main view of the main screen 302 is in a tile display format that provides an overall summary of a user's friends represented by user tiles and subjects of common interest represented by group tiles. The application generally allows a user to react to friends as well as group tiles by entering scores and related information such as comments and photos. The users may also submit scores on the related information. The application allows a user to see what subjects (e.g., teams, television shows, movies, etc.) are trending in terms of score changes, how friends are feeling, how celebrities are feeling, etc. The user may control the application and only share the emotional scores they enter with the user's friends. The application also allows the user to control the application so friends may only see the user's specific emotional scores, if the friends allow the user to see their own emotional scores. The application may include promotional options where a user may be awarded points for entering scores on different tiles. Such points may be used for promotions or to unlock other features in the application.

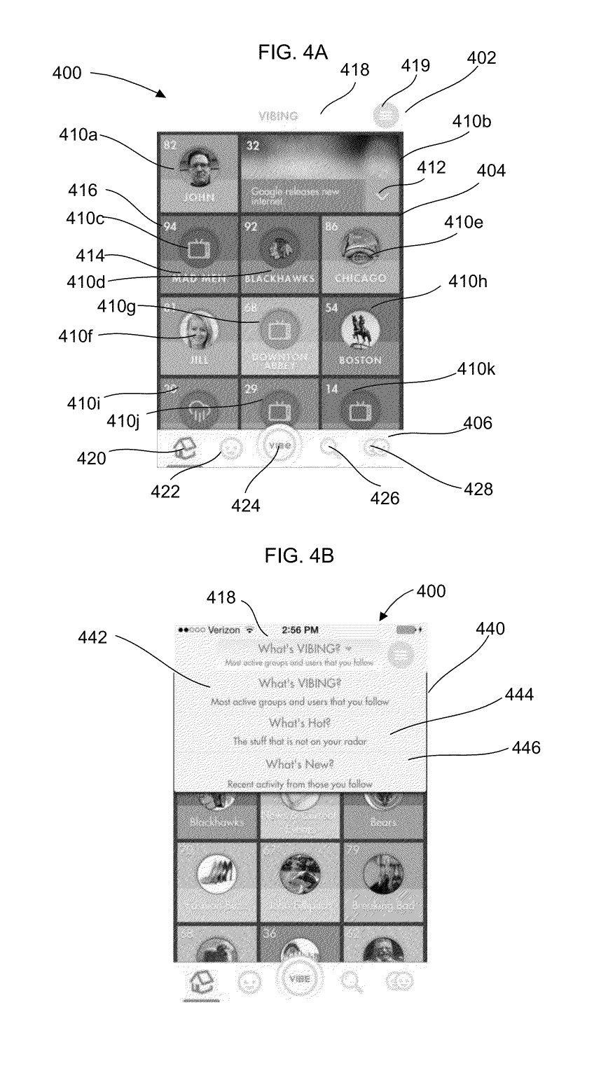

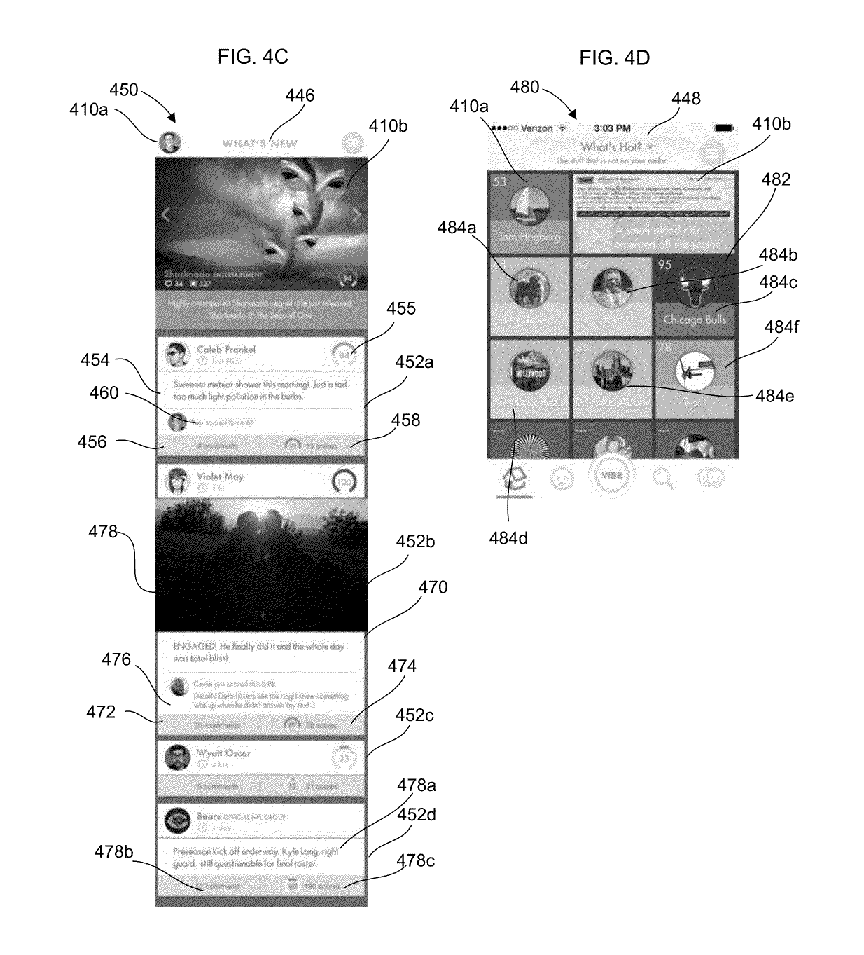

FIG. 4A is an image 400 of the main view screen 302 in FIG. 3 which is displayed to a user after logging into the application from a user device. The main view screen 302 includes a menu bar 402, a tile area 404, and a tools menu 406. The tile area 404 includes a plurality of tiles 410a-k each representing either the user, friends of the user or different subjects of common interest. The user tile is always displayed on the top of the tile area 404 as shown by the tile 410a, which represents the user. A trending news tile 410b is also always displayed at the top of the tile area 404. The trending news tile 410b is a tile that is displayed for all application users that streams the latest news updates from the application server 102. The news tile 410b is controlled by the system administrator and cycles through different items which may be of interest to application users. The news items may be linked to other tiles which may be followed by application users. The news tile 410b includes a news field 412 that shows a summary of the latest news update along with a score and an optional graphic. As will be explained below, the score is calculated from score data submitted by application users. The news field 412 may be expanded to display the full story associated with the news item.

The tiles representing the users of the application who are friends of the user and subjects of common interest that have groups of followers are stored in the application storage database 122 in FIG. 1. The tiles are updated in terms of comments and scores and are provided to users associated with each tile by the application server 102. Friends of the user may be associated with a user tile such as the tile 410f As explained below, friends are other users of the application who have mutually agreed to be friends with the user and therefore allow their tiles to be displayed on the main view screen 302 associated with the user.

Tiles may also be associated with different groups representing subjects of common interest such as tiles 410c, 410d, 410e, 410g, 410h, 410i, and 410j. Example group tiles may include tiles associated with sports, a zone/location, bands/music, television shows, movies, celebrities, current events, books, restaurants, public feeds, consumer brands, colleges, public businesses, political parties, pets, etc. The tiles 410c-410k may be moved by a user at any location in the tile area 404 via an input from the user device or may be displayed according to the level of activity in those tiles or other criteria by the application. For example, the tiles may be ordered by the highest to lowest current score. Alternatively the tiles may be ordered by the tile receiving a score or comment most recently. Alternatively, the tiles may be ordered by the amount of user scoring activity over a set period of time with the most active tiles being displayed at the top of the area.

An example tile is a group tile such as the group tile 410c representing a subject of common interest, in this example a television show. The tile 410c includes an identification field 414, and a score 416. The identification field 414 includes the name of the tile and a graphic or icon, which in this example represents the type of category (e.g., television) or subcategory (e.g., a television show) that the tile is classified as. Alternatively, the graphic may be specific to the tile such as a team logo or other symbol. The graphic may also be the last image that was posted by a user or by a system administrator. The color of the tile may change based on the current score of the tile. For example, higher scores may have certain colors such as red or orange while lower scores may have colors such as blue.

The name of the tile and the graphic of the identification field 414 for a particular tile is selected by the user in the case of a friend tile such as the tile 410e or the system administrator via the application server 102 in FIG. 1 in the case of the group tile such as the tile 410c. Sponsors may be given a tile for a specific group for a sponsorship or advertising fee. Such group tiles may allow the selection of a specific icon by the sponsor. Alternatively, users may also create and name group tiles with or without the approval of the system administrator. In such a case, a specific user or users may be designated as an administrator for the subject matter and content posed relating to the tile. The score 416 represents the collective scoring data of all users that have a common interest in the tile which is compiled by the server 102 in FIG. 1 and sent to all user devices of users who follow the particular tile. In this example, the score 416 is determined by an aggregation formula for all collected scores.

In this example, the score 416 may be determined based on the following equation to determine the post score, Pₙ. The score is the average of all the scores for post n (0 is the most recent, 1, second most, etc. to n which is the least recent)

$$\frac{{P}_{0} {W}_{0} + {P}_{1} {W}_{1} + {P}_{2} {W}_{2} + {P}_{3} {W}_{3}}{{W}_{0} + {W}_{1} + {W}_{2} + {W}_{3}}$$

In this equation, Wₙ is the calculated weight of the nth post. The weight of each post, Wₙ is determined by the following equation

$$W = b ( 1 + \frac{S}{F} )$$

In the above equation, b is a constant factor decided by the administrator. In this example, b is decided based on the magnitude of the importance of the post. For example, more important posts have higher constant factors. S is the number of people that scored that post and P is the number of people following that group.

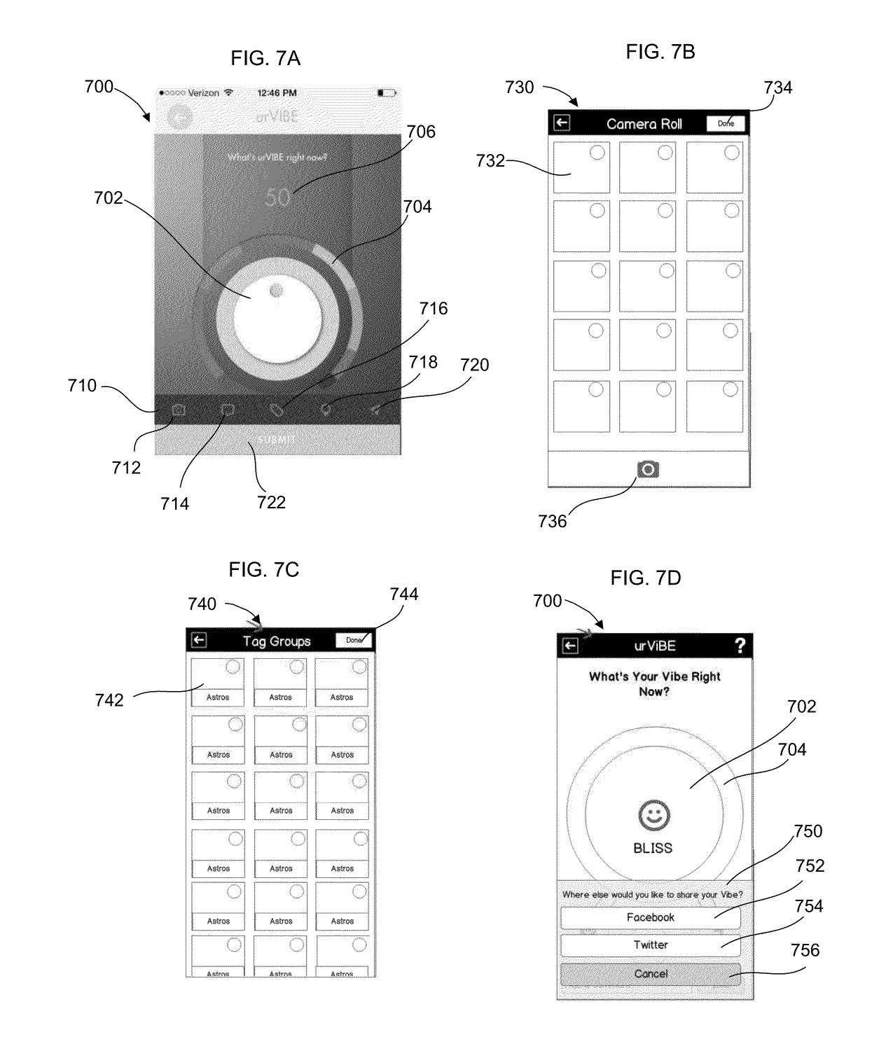

The image 400 of the main view screen 302 displays all tiles associated with the user of the user device such as the tiles 410a-k. Each tile 410a-k may be updated when the user or other users enter a score relating to that tile and a related comment is made. The location of the tile may be changed on the main view screen 302 depending on how recently a user changes their individual score on that tile or according to other criteria such as how active the tile is or the value of the score (e.g., the tiles with the highest scores are placed at the top of the screen). The application requires a user to enter a score for active tiles displayed on the main view screen 302 before displaying updated scores thereby providing an incentive for users to enter updated scores. For example, if a user has not entered a score for their own tile within a 24-hour period, the application will display a scoring screen such as that in FIG. 7A before allowing the user access to the main screen 302. However, other time periods may be used to require an update of the tiles 410a-k. In this example, a user must enter a score for their individual tile 410a on a daily basis while scores are required for group tiles such as the tiles 410c or 410f at least once every three days. Alternatively, the length of time required for group tiles may depend on the subject matter of the group or may otherwise be set by the administrator of the application.

A user may move the tiles 410c-k by using a touch screen or another input device on the user device. Alternatively, the tiles may be provided with dynamic characteristics that move in position based on activity from the user or other users as will be explained in reference to FIG. 4B. The score number displayed by each tile 410c-410k may update for the tile after users enter an updated score. An indication of a new score and the new score (if updated) will be broadcast to all users who follow the specific tile as will be explained below.

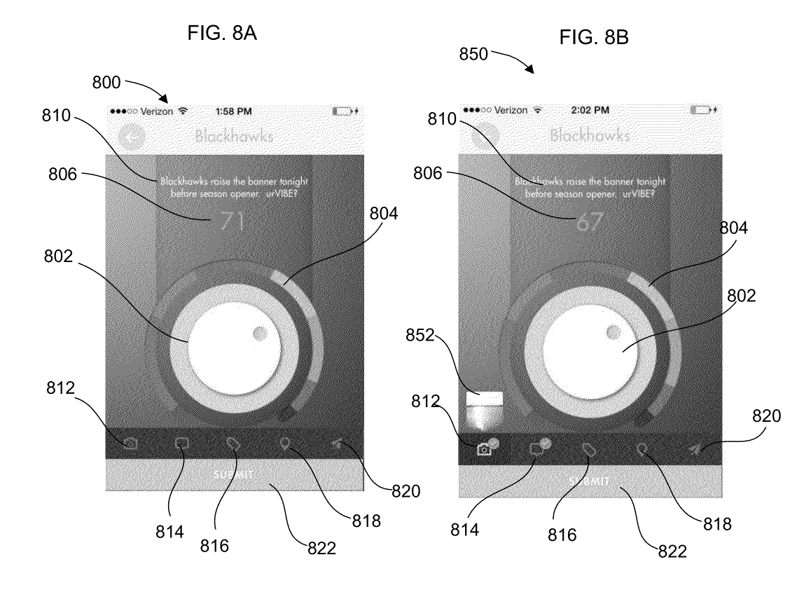

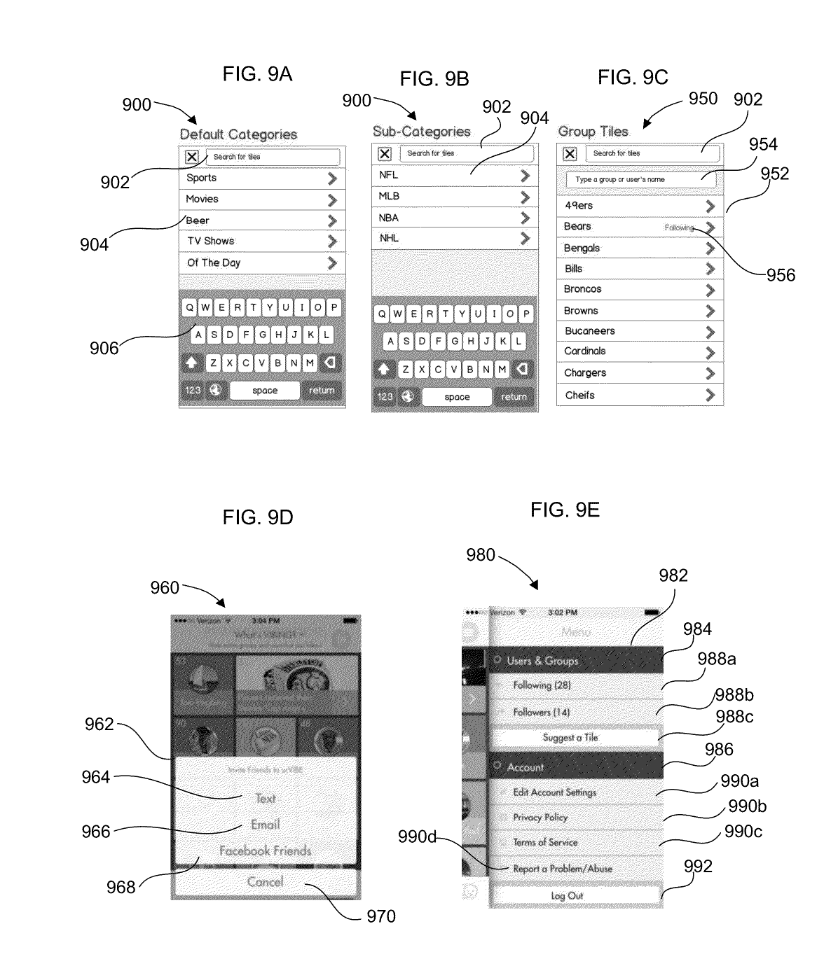

The menu bar 402 includes an order tile button 418 which when selected shows a pop-up menu that allows a user to change the display and or order of the tiles on the main screen image 400. The order tile button 418 indicates how the tiles are displayed on the tile display area 404. In this example, the default option (“What's Vibing”) allows tiles to be displayed according to those tiles that have had the most recent updates in scores. The menu bar 402 also includes a menu icon 419 which allows navigation to different screens via a pop-up menu. The tools menu 406 at the bottom of the screen appears in all screens such as the tile information screens 306, 308 and 310 in FIG. 3 and includes icons that allow navigation between screens. The tools menu 406 includes a home icon 420 that returns the user to the main screen 302, a profile icon 422, a scoring icon or button (VIBE) 424, a search icon 426 and an add person icon 428. Selecting the profile icon 422 allows a user to view and edit their personal tile such as the tile 410a in FIG. 4A. The scoring icon 424 allows access to a scoring tool for a personal tile as explained below with reference to FIGS. 7A-7D in the case of access from the main screen 302 and FIGS. 8A-8B for adjusting the score of a group tile in the case of access from a group tile information screen 310. Selecting the search icon 426 allows a user to find new tiles associated with friends or groups as explained below with reference to FIGS. 9A-9C. Selecting the add person icon 428 allows a user to add friends or followers as will be explained below with reference to FIG. 9D.

FIG. 4B is an image of the main screen 302 when a user selects the order tile button 418 in the menu bar 402 which causes a selection menu 440 to be displayed over the main screen 302. The selection menu 440 in FIG. 4B includes a VIBING selection 442, a “what's hot” selection 444, and a “what's new” selection 446. Each of the selections 442, 444 and 446, when selected, reorganize the tiles displayed to a user in the tile display area 404. The selections 442, 444, and 446 each result in a different description of the tiles being displayed on the order tile button 418 in the main screen 302. As explained above, followers are those users of the application who follow a user but with whom certain information is not shared. Followers can also be associated with group tiles. The VIBING selection 442 displays group tiles by either a high volume of activity from users following the group or drastic score changes. The VIBING selection 442 is the default display format. The “what's hot” selection 444 allows the display of active group tiles for which the user is not following. The user may choose to become a follower of one of the displayed tiles by selecting the tile as will be explained below. The “what's new” selection 446 allows the display of tiles in the order of new content associated with the tiles.

Other display ordering options may be made available. For example another option may be a “my friends” selection which displays the tiles of friends such as the tile 410f in FIG. 4A in expanded format. The expanded friend tiles show a current score reflecting how the user is feeling, a comments field for comments made by the friend and a comment option that allows the user to make a follow up comment on the comment entered by the friend.

FIG. 4C shows a tile display screen 450 that is displayed when the “what's new” icon 446 is chosen from the selection menu 440 in FIG. 4B. The tile display screen 450 displays certain tiles from the main display 302 in a different format and places the “hottest” tiles first according to criteria such as the most recently entered scores of the most recent comments posted by users in these tiles. As shown in FIG. 4C, the “me” tile 410a, represented by the photo icon, and the news tile 410b remain at the top of the tile display screen 450. Tiles in FIG. 4A such as the tiles 410c-k are displayed in the order of tiles having the most recent comments on the tile display screen 450 in FIG. 4C. Expanded tile fields 452a, 452b, 452c or 452d are displayed for each tile that includes recent comments made by other users. Each expanded tile field 452a, 452b, 452c and 452d in FIG. 4C displays the associated graphic, tile name and current score identical to those in the tiles 410a-k in FIG. 4A.

The first expanded tile 452a relates to the tile 410f in FIG. 4A. The expanded tile 452a allows a user to view comments and scores from other application users who are friends of the user. As shown in FIG. 4A, the expanded tile 452a includes a posting field 454 which has been posted with a subject sentence or phrase for soliciting comments from users. The time that a comment is made is displayed in all comment fields and a corresponding score 455 from the poster is displayed in the expanded tile 452a. Additional postings may be made by selecting a comment button 456. The comment button 456 shows how many comments have been made and when selected allows the user to enter a comment on the subject of the posting field 454. A score button 458 allows a user to enter a reaction score on the posting. The score button 458 displays the overall reaction score in relation to the posting as well as the number of reaction scores entered related to the posting. In this example, the user has entered a score and thus an individual score field 460 is displayed.

Another expanded tile 452b relates to another user who is a friend of the application user. The expanded tile 452b includes a posting field 470, a comment button 472 and a score button 474 similar to those explained above. In this example, the user submitting the post has attached a photo 478 that is displayed on the tile display screen 450. In this example, a comment field 476 that shows a comment from another user is displayed. The comment in the comment field 476 includes the user icon and the score as well as the comment. The comment button 472 may be selected to add a comment and the score button 474 may be selected to enter a reaction score to the comment.

Another expanded tile 452d is a group tile which follows a subject of interest to the user. In this example, the expanded tile 452d includes a posting field 478a, a comment button 478b and a score button 478c similar to those of the individual tiles 452a and 452b. As with the expanded tile 452b, a comment has been entered in the posting field 478a and the score button 478c shows the average reaction score of those scoring the comment as well as the number of users scoring the comment.

FIG. 4D shows a tile display screen 480 that is displayed when the “what's hot” selection 444 is selected from the selection menu 440 in FIG. 4B. The display screen 480 allows a user to display tiles that have recent activity but are not followed by the user. As shown in FIG. 4D, the “me” tile 410a and the news tile 410b remain at the top of the screen 480. Additional tiles that are not followed by the user are displayed in a tile display area 482. Thus, tiles 484a, 484b, 484c, 484d, 484e and 484f relating to subjects of potential interest are displayed. These tiles differ from the tiles 410c-k in FIG. 4A since the user does not follow the tiles shown in the tile display screen 480. A user may select any of the tiles 484a-f and become a follower of the selected tile.

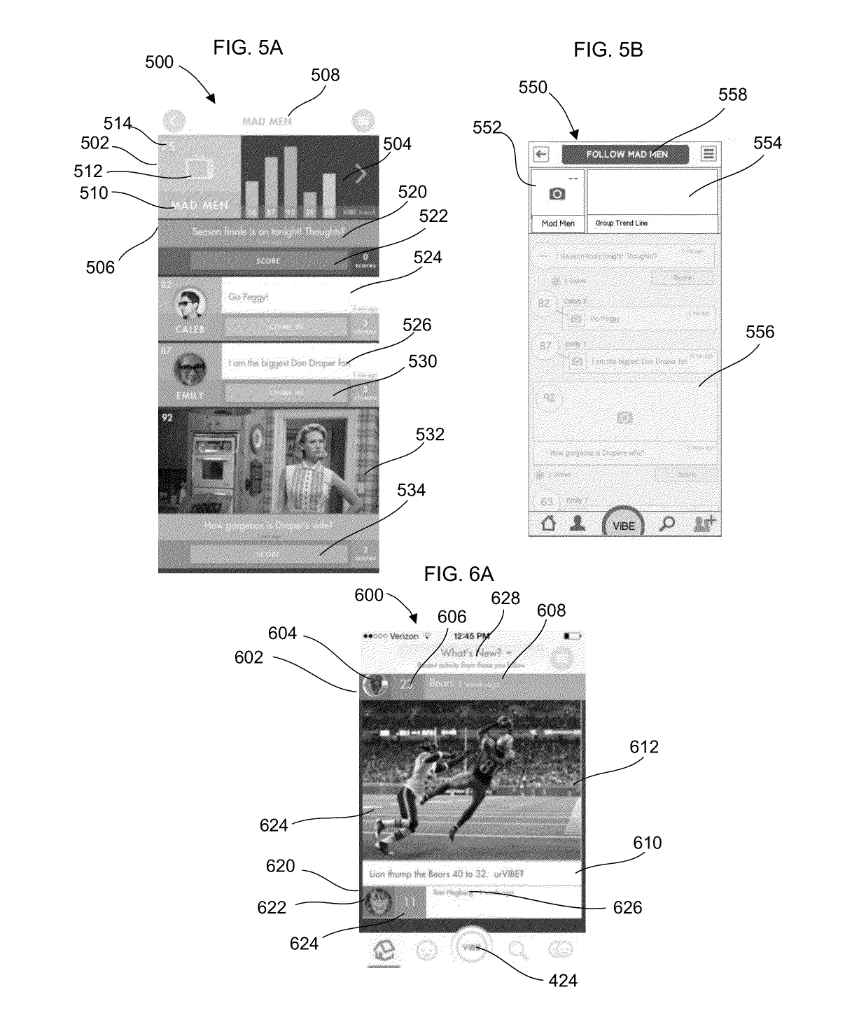

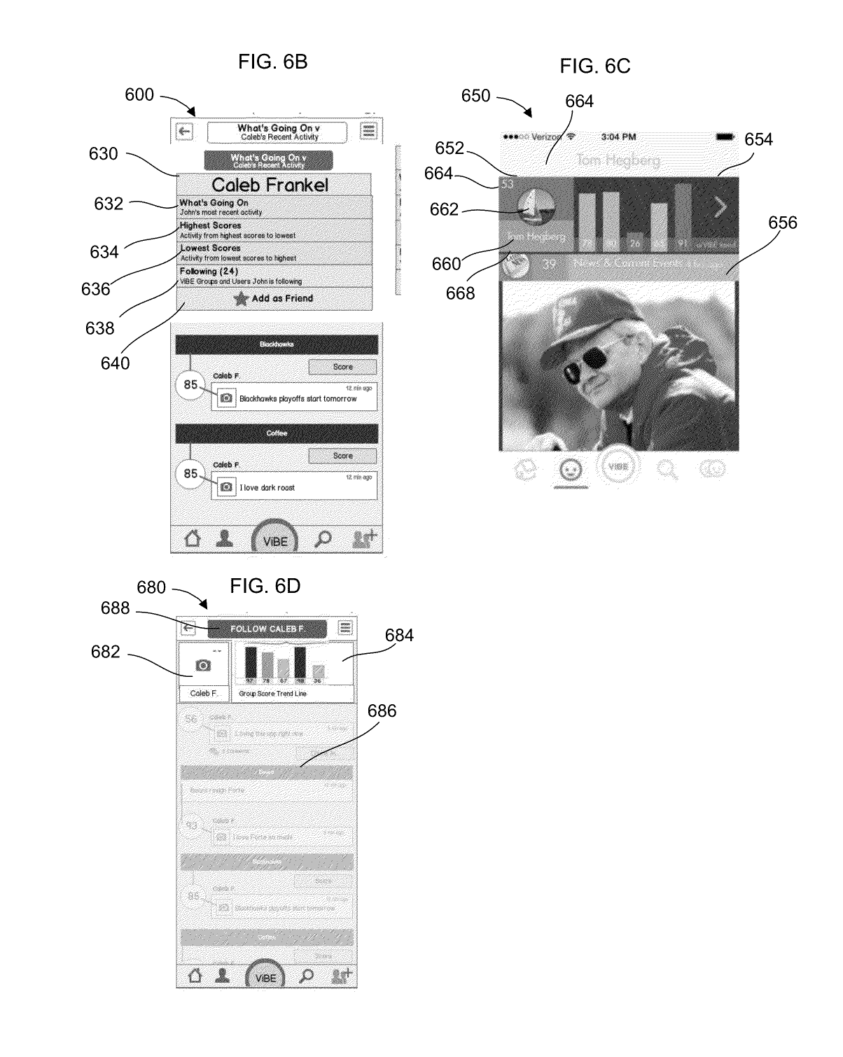

The application allows a user to select tiles and display greater detail associated with the tile such as the screen 310 for group tiles or the screen 308 for friend tiles in FIG. 3. The tile information shown depends on the type of the tile and whether a user is a follower or a friend as shown in FIG. 5A-5B and FIG. 6A-6C. FIG. 5A shows a group tile screen 500 which is displayed when a group tile such as the tile 410f in FIG. 4A is selected by a user. The group tile screen 500 is also displayed whenever a tile is selected in any other screen with tiles such as the tile display screen 450 in FIG. 4C. The group tile information screen 500 includes a tile image 502, a trend field 504 and a posting area 506. The top menu 402 includes a status field 508 which indicates that the user is displaying the tile field for the selected tile. The tile image 502 is similar to the tile images which include the name of the tile 510, a corresponding image 512 and a score 514 representing the compilation of user scores for the tile. The trend field 504 shows a graph which tracks the scores of users in relation to the tile over a predetermined time period which shows the trending of scores associated with the tile over the time period. For example, the trend graph shows the aggregate score of the tile over the last ten days. Other time periods may be used to show trends in the trend graph. The trend graph may be adjusted to show other trends based on demographic filtering or show other information compiled in the storage server 122 relating to the particular tile.

The posting area 506 includes postings made by users or the system administrator. One example of a group posting is a subject sentence or phrase for user comment, such as the posting 520. The posting 520 includes a scoring button 522 which allows the user to score the particular comment. Other users may include comment postings such as the comment postings 524 and 526 which include scores associated with users who posted the posting. A user does not have the ability to score such postings. Other postings, such as a comment posting 530, allow a user to post an image 532 along with the score they post. Similar to the group posting 520, the comment posting includes a score button 534 for a user to enter a score on the subject. A user may scroll down to see older postings in the screen 500.

When a group tile icon is selected for which the user is not a follower, a tile information screen 550 is displayed as shown in FIG. 5B. Similar to the group tile screen 500, the tile information screen 550 includes a tile image 552, a trend field 554 and a posting area 556. The tile information screen 550 in FIG. 5B includes a follow group tile button 558 in the top menu 402. Unlike the tile image 502 in FIG. 5A, the tile image 552 does not include a score for the tile since the user is not a follower. Thus, the user is incentivized to become a follower to view the score of the group represented by the tile. The posting area 556 includes posts similar to the posts in the posting area 506 in FIG. 5A. However, the posting area 556 is grayed out, which represents a view only status. The user cannot enter scores or comments until the user becomes a follower of the group. The user may become a follower of the group by selecting the follow group tile button 558.

Another tile display may be shown for following an individual user who is not a friend of the user as shown by the follower tile information display 600 in FIG. 6A. The display 600 is only available if the application is configured to allow individual users to have followers and if the followed user has allowed followers to view their individual tile. The follower tile information display 600 allows a user to see certain information from a tile associated with another user but does not allow the user to enter scores or comment for the tile. The follower tile information display 600 is displayed whenever a user tile displayed on any screen is selected. As explained above, being a follower is a one-way relationship, the user who is a follower can only see group scores and cannot see personal scores from the other user who is being followed. The follower tile information display 600 includes a tile 602 that represents a tile being followed by the selected user. The tile 602 includes an icon 604, a score 606, a name field 608, a comment field 610 and an optional photo 612. A followed user field 620 includes information relating to the followed user. The followed user field 620 in this example includes a user icon 622, a user score 624 and a user name field 626. The user score 624 represents the score the followed user entered relating to the tile. The followed user field 620 also includes information when the most recent score was entered by the followed user.

Other tiles the user is following may be displayed on the display 600. A display button 628 may allow a user to rearrange the order of the tiles display in FIG. 6A. A positing field (not shown) includes postings made by the particular user associated with each listed tile. As explained above, since the user is only following the particular user associated with the tile, the user does not have the ability to enter scores or comments. The display 600 may also include tile fields representing postings made relating to users that are friends with the user associated with the display 600. The user may display a tile information display screen such as the tile information screen 500 in FIG. 5A or the tile information screen 550 in FIG. 5B by selecting the particular tile such as the tile 602. Certain tiles in this example may also be followed by the user and therefore the user may enter a score via the scoring button 424 on those files.

FIG. 6B shows a pop-up menu 630 that is displayed on the screen 600 when the button 628 is selected in FIG. 6A. The pop-up menu 630 includes a “what's new” selection 632, a highest scores selection 634, a lowest scores selection 636, a “following” selection 638 and an add friend selection 640. The “what's new” selection 632 shows the display 600 in FIG. 6A which orders the postings made by the user associated with the follower information display 600 chronologically. Selecting the highest scores selection 634 displays tiles which the user associated with the follower display 600 scored the highest. Selecting the lowest scores selection 636 displays tiles which the user associated with the follower display 600 scored the lowest. Selecting the following selection 638 lists all of the tiles that the particular user associated with the follower display 600 is following. The following selection 638 also includes the number of tiles the particular user associated with the follower display 600 is following. The add friend selection 640 makes a request to the particular user associated with the follower display 600 to friend the user. If the request is accepted, the user and the user associated with the display 600 are linked as a friend relationship.

FIG. 6C is an example of a friend user tile information display 650. The friend tile information display 650 is shown when a tile associated with another user who is a friend of the user is selected in any screen. The friend user tile information display 650 allows a user to see certain information from another user tile such as the tile 410f in FIG. 4A and allows the user to enter scores or comment (chime in) because the other user has agreed to be a friend to the user. The friend user tile information display 650 includes a tile image 652, a trend field 654 and a news area 656. The tile image 652 is similar to the tile images which include a name label 660 (the user associated with the tile), a corresponding image 662 (usually a user's photograph) and a score 664 representing the compilation of user scores for the tile. The trend field 654 shows a graph which tracks the score of the tile over a predetermined time period which shows the trending of scores associated with the tile.

The posting area 656 includes postings made by the particular user associated with the display 650 in relation to both comments relating to the user and group tiles. The posting area 656 includes a personal comment field 664 which displays comments made by the user associated with the display 660 relating to the tiles associated with the user. The user comment field 664 includes a chime in button 666 that allows the user to add a comment. The user comment field 664 also includes a score 668 which may be viewed by the user because of the friend status with the other user associated with the display 650. The posting area 656 is organized by group tile fields 670a, 670b, 670c which are group tiles that the particular user associated with the display 650 has commented on recently. The user may enter a tile information screen by selecting the particular tile field 670a-670c. Certain tiles such as the tiles 670b and 670c in this example, are also followed by the user and therefore the user may enter a score for those tiles via the score button 672.

When a user tile is selected for which a user is not a follower, a user tile information display 680 is displayed as shown in FIG. 6D. Similar to the user information display 600 in FIG. 6A, the user tile information screen 680 includes a tile image 682, a trend field 684 and a posting area 686. The tile information screen 680 in FIG. 6D includes a follow group tile button 688 in the menu area 402. Unlike the tile image 602 in FIG. 6A, the tile image 682 does not include a score for the tile since the user is not a follower. Thus, the user is incentivized to become a follower to view the score of the user represented by the tile information screen 680. The posting area 686 includes posts made by various users. However, the posting area 686 is grayed out which represents a view only status. The user cannot enter scores or comments until the user becomes a follower of the user represented by the tile information screen 680. The user may become a follower of the user associated with the user tile information screen 680 by selecting the follow user tile button 688.

FIG. 7A is an image of a score input tool screen 700 that appears when a user selects a score button, such as the vibe button 424 in the main screen 302 in FIG. 4A, the score button 620 in FIG. 6A or the score button 672 in FIG. 6C, to enter an individual user score. Such a score input tool screen 700 is accessed when the application prompts the user for a score, such as the periodic personal score, that the user is requested to enter for the personal “me” tile 410a in FIG. 4A. Alternatively, the application may incentivize the user to enter a personal score by only displaying the score input tool screen 700 and locking access to all other tiles followed by the user shown in the main screen 302 until a score is entered.

The score input screen 700 includes a dial tool 702. The dial tool 702 includes a range between a low score and a high score. The range of scores is 1-100 in this example which is indicated by the position of the dial tool 702. The user may use a touch screen or another input device to adjust the dial 702 to enter the desired score. A circular scale 704 is provided to show the range of potential scores in relation to the position of the dial tool 702. The circular scale 704 may have sections of different colors corresponding to the range of scores selected by the user. A numerical score 706 is displayed which reflects the position of the dial tool 702. The dial tool 702 may therefore be adjusted to the section that corresponds with the desired score. The different colors may be consistent with the color of the tiles displayed based on the score value. The numerical score 706 may be displayed in a color that is consistent with the section corresponding to the range the score falls in.

A posting menu 710 includes options to modify the entered score. The posting menu includes a camera icon 712, a comment icon 714, a tag icon 716, a location icon 718 and a share icon 720. Selecting the camera icon 712 allows a user to attach a photograph to their score. Selecting the comment icon 714 allows a user to enter a comment along with their score. Selecting the tag icon 716 allows a user to link different tiles to the tile that the score is associated with. Selecting the location icon 718 allows a user to add location data to the score. Selecting the publish icon 720 allows a user to publish the score to other social media applications. A submit button 722 allows a user to enter the score and thereby sends the new score to the central server 102 in FIG. 1 allowing for score updates to followers and friends as well as aggregation for updating aggregate scores. Alternatively, different buttons could be used for personal scores via a “daily vibe” for the tile. An alternate button could be a post button which allows a user to request scores for a post associated with the tile.

The screen 700 may include a toggle switch that provides the user the ability to toggle between public and private. The public setting shares the user's score with other users, the private setting prevents sharing with other users. The face of the dial 702 may include an emotive icon which reflects the numerical score represented by the dial tool 702. The image of the emotive icon reflects the numerical score. For example low scores may have unhappy faces while high scores may be a happy face. In addition, the color of the emotive icon or the dial tool 702 itself may also change to reflect the score given by the user. An associated word expression may be displayed under the emotive icon which expresses the score.

In this example, a user may customize the emotive icon and the word expression associated with each emoticon icon. For example, a user may purchase additional emoticons or a points system may allow the acquisition of points. Additional emoticons may be based on other types of graphics. Each emoticon icon represents increments of numerical scores. In this example, the scores may range from 1 to 100 and each emotive scoring icon may represent an increment of 10. As explained above, the color of the emoticon may change every increment of 10 in the displayed score. The representative word changes with every increment of 10 in the displayed score. The user may select different representative words that may be associated with a specialized emoticon icon.

Different styles emotive icons may be offered to users via the application, or more specialized emotive icons could be purchased by a user using points or other earned credits. For example, customizable icons may include sets of photographs, famous front pages, from Man Walks on Moon to Hindenburg Disaster, Hollywood beauties (10 different stars or user favorites displaying 10 degrees of emotion), famous photographs, from the Sailor Kissing the Nurse to the end of WWII to Depression Era photos, moments in sports, famous works of art, etc. Other examples may include moments from a particular movie or TV show, again showing a range of emotions. Sponsors may offer the different emoticons which may also be tied to a group tile.

FIG. 7B is an image of an add photo selection screen 730 activated from the score tool screen 700 when the camera icon 712 is selected. The photo selection screen 730 displays photos for a user and allows the user to attach a photo to the score entered in the score screen 700. The photo selection screen 730 includes multiple photo thumbnails 732 which may be selected and attached to the entered score by selecting the done button 734. A camera icon 736 may be selected for a user to take a photo using the mobile device and add the photo to the photo selection screen 730.

FIG. 7C is an image of a tag group screen 740 activated by selecting the tag icon 716 of the score tool screen 700 in FIG. 7A. The tag group screen 740 allows a user to link the entered score to group tiles that the user follows. The tag group screen 740 includes tile icons 742 that represent the tiles followed by the user. By selecting the tile icons 742, the user links the entered score to the selected groups. The scores are linked by selecting the appropriate tile icon 742 and selecting a done button 744. The resulting linked tiles are represented in any comments made for the user as shown in FIG. 4C.

FIG. 7D is an image of a share group pop up menu 750 activated from selecting the publish icon 720 in the score tools screen 700. The share group screen 750 includes buttons representing accounts of the user on other social media programs. For example, the user may select buttons 752 and 754 representing FACEBOOK® and TWITTER® and publish the score on their respective accounts on those applications. When either of the buttons 752 and 754 is selected, requests are sent to servers such as the social network server 120 in FIG. 1 that operate the particular social media application. The user may cancel posting by selecting the cancel button 756.

FIG. 8A is an image of a scoring input screen 800 for scoring a tile associated with a group. The scoring input screen 800 is displayed when a score button is selected associated with a group tile such as the score button 522 in FIG. 5B. The score input screen 800 includes a dial tool 802. The dial tool 802 includes a range between a low score and a high score. The range of scores is 1-100 in this example, which is indicated by the position of the dial tool 802. A circular scale 804 is provided to show the range of potential scores. The circular scale 804 may have sections of different colors corresponding to the range of scores selected by the user. A numerical score 806 is displayed which reflects the position of the dial tool 802. As explained above, the dial 802 may also include an emotive icon to indicate the score.

A post area 810 is displayed which reminds the user that the score is being entered relative to a posting for the particular tile. Similar to the score input screen 700, the score input screen 800 includes a camera icon 812, a comment icon 814, a tag icon 816, a location icon 818, a share icon 820 and a submit button 822 for submitting the score.

FIG. 8B is an image of another scoring tool screen 850 that includes a photograph 852 in relation to a comment posting that is shown in the posting field 810. The scoring tool screen 850 is displayed when a score button is selected associated with a group tile such as the score button 424 in FIG. 4A for a comment relating to a tile. The score input screen 850 includes the dial tool 802, scale 804, score 806, the camera icon 812, the comment icon 814, the tag icon 816, the location icon 818, the share icon 820 and the submit button 822 similar to the scoring tool screen 800 in FIG. 8A.

FIG. 9A is a search screen 900 which is displayed when the search icon 426 is selected in any of the above mentioned screens such as the main view screen 302 in FIG. 4A. The search screen 900 allows a user to find different tiles and includes a search field 902, a categories field 904 and a keyboard 906. The user may enter search terms in the search field 902 via the keyboard 906 to find specific tiles by name. The search will also result in displaying tiles associated with other users. The categories field 904 lists various categories of tiles related to subjects of interest which may then be selected by the user.

FIG. 9B shows the search screen 900 when one of the specific categories in the categories field 904 in FIG. 9A is selected. In this example, the category of sports has been selected and FIG. 9B shows that the categories field 904 now shows different leagues relating to sports teams. The organization of categories is in the form of a tree with tiles at the bottom of the tree structure having categories and subcategories.

Each of the categories shown in FIG. 9B may therefore be further expanded to show sports teams in a particular league by selecting the category. As shown in FIG. 9C, a search results screen 950 will list tiles relating to NFL teams in a tiles listing area 952 which were selected when the NFL category was selected in FIG. 9B. An additional search field 954 allows a search for a group or a user's name. The tiles representing a tile where a user is a follower will be highlighted as shown in a tile row 956. Any of the tiles listed in the tiles listing area 952 may be selected to display the tile in a screen similar to that shown in FIG. 5B if the user is not a follower or a screen similar to that shown in FIG. 5A if the user is already a follower of the group.

FIG. 9D is an invite friend/follower screen 960 displayed when the add person icon 428 is selected in any screen such as the main screen 302 in FIG. 4A. An invite pop up menu 962 is displayed which overlays the screen such as the main screen 302. The invite pop up menu 962 includes a text selection 964, an email selection 966 and a social media selection 968. The text selection 964 allows a user to text another person to invite them to join the application. The email selection 968 allows a user to email another person to invite them to join the application. The social media selection 968 allows a user to access a social media application such as FACEBOOK® that may be run on the user device and invite a person accessible via the social media application such as a FACEBOOK® friend request. Other selections may be included to access other communication media to reach out to others to invite them to join the application. A cancel key 970 allows a user to exit the invite pop up menu 962.

FIG. 9E is an option selection screen 980 for a user to control various settings of the application that is accessed by selecting the menu button in any screen such as the menu button 419 in FIG. 4A. Selecting the menu button overlays a settings menu 982 over the current screen. The settings menu 980 includes a “users and groups” selection 984 and an account selection 986. The user may exit the application by selecting a log out option 992.

The “users and groups” selection 982 includes selection options that allow a user to access various tiles that are associated with the user. The “users and groups” selection 982 includes a following selection 988a, a followers selection 988b and a “suggest a tile” field 988c. The following selection 988a includes a number that represents the number of tiles that the user is following. Selecting the following selection 988a will display a list of the tiles that the user is following. The followers selection 988b includes a number representing the number of followers or friends of the user. Selecting the followers or friends selection 986b will display a list of the users that are followers or friends of the user. The “suggest a tile” field 986b allows a user to send a request for a new tile to the system administrator.

The account selection 986 allows a user to adjust various settings in their account associated with the application. The account selection 986 includes an edit account settings 990a, a privacy policy selection 990b, a terms of service selection 990c and a report a problem selection 990d. The edit account settings 990a will display an account screen and allow a user to edit information relating to the account such as the e-mail, the user name, password, etc. The privacy policy selection 990b allows a user to read the privacy policy of the application. The terms of service selection 990c displays the terms of service for the application. The report a problem selection 990d allows a user to communicate to the application administrator by email or other means and report problems or register complaints.

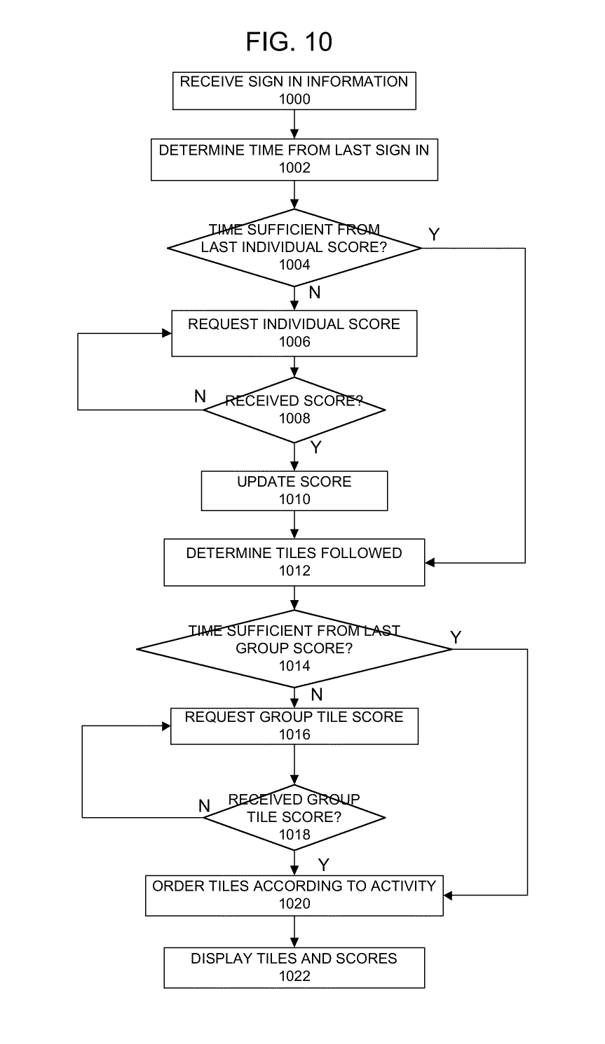

The operation of the example system 100 shown in FIG. 1, which may be controlled on the example server and user devices, will now be described with reference to FIG. 1 in conjunction with the flow diagram shown in FIG. 10. The flow diagram in FIG. 10 is representative of example machine readable instructions for implementing the application to collect and distribute emotive scores from users. In this example, the machine readable instructions comprise an algorithm for execution by: (a) a processor, (b) a controller, and/or (c) one or more other suitable processing device(s). The algorithm may be embodied in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the interfaces could be implemented by software, hardware, and/or firmware. Also, some or all of the machine readable instructions represented by the flowchart of FIG. 10 may be implemented manually. Further, although the example algorithm is described with reference to the flowcharts illustrated in FIG. 10, persons of ordinary skill in the art will readily appreciate that many other methods of implementing the example machine readable instructions may alternatively be used. For example, the order of execution of the blocks may be changed, and/or some of the blocks described may be changed, eliminated, or combined.

FIG. 10 is a flow diagram for the process of gathering and displaying scores relating to subjects of common interest for the application running on the server 102 in FIG. 1. A user first signs in and the server 102 receives sign in information via the network 108 (1000). The sign in information is matched to the account of the user in the database 122. The server 102 then determines the time from the last sign in on the application by the user (1002). The server 102 determines whether the user has entered a score in a personal tile such as the “me” tile 410a in FIG. 4A within a predetermined time period such as during a 24-hour period (1004).

If a user has not entered a score over a period of time, the server 102 will request a score from the user for their personal score (1006). The server 102 will determine whether updated scores are received (1008). If no updated score is received, the server 102 will continue to request an updated score from the user (1006). If an updated score or scores are received, the application will update scores for the relevant tiles associated with the user (1010).

After the scores are updated (1010) or if the application determines that the user has entered a personal score within a sufficient period of time (1004), the application will determine the tiles associated with the user (1012). The application will determine the time that a user has entered a score for the associated tiles (1014). If the user has entered a score within an acceptable period of time (1014), the application will proceed to step 1020. If the user has not entered a score for the predetermined period of time for a group tile or tiles, the user will be prompted to update their scores for the tiles (1016). Of course other criteria may be used to decide whether a user will be prompted to enter an updated score. Such criteria may depend on the subject matter of the specific tile to be scored. The application determines whether a score has been entered (1018). If a score is not entered, the application will continue to request updates to group tiles followed by the user (1016) to provide an incentive to update scores. If the scores are entered for the group tiles, the application will proceed to step 1020.

The application will then order the tiles for display according to the activity on the associated tiles for the user device (1020). The application on the user device will then display the tiles and associated scores (1022).

Each of these embodiments and obvious variations thereof is contemplated as falling within the spirit and scope of the claimed invention, which is set forth in the following claims.

What is claimed is:

1. A method of compiling scoring data from users of user devices in communication with a central server, the method comprising:
associating a tile relating to an area of common interest to a user;
displaying the tile with a current score to the user on a display of a user device;
requesting an updated score from the user based on the user's feelings relating to the area of common interest;
receiving an updated score from the user associated with the area of common interest; and
displaying scores from other users when the updated score is received.

2. The method of claim 1, wherein the score includes an icon representing one of a range of scores.

3. The method of claim 2, wherein the icon is selected by the user.

4. The method of claim 1, wherein the tile includes a tile name, a graphic and the score.

5. The method of claim 1, wherein the area of common interests includes at least one of a personal tile, a tile associated with another user and a group tile associated with a topic of interest.

6. The method of claim 1, wherein the request for an updated score is made after a predetermined period of time has elapsed where the user has not entered a score.

7. The method of claim 1, wherein the user may have a relationship with another user having an associated tile.

8. The method of claim 7, wherein associated tile of another user includes tiles of common interests associated with the another user and wherein the user may post comments or scores on the associated tiles.

9. The method of claim 1, wherein a plurality of tiles associated with areas of common interests is displayed, and wherein the order of tiles on the display may be changed based on a predetermined criteria.

10. The method of claim 1, wherein the updated score includes either a comment or a photograph entered by the user with the entered score and wherein the comment or photograph is broadcast to other users associated with the tile.

11. The method of claim 10, wherein other users may enter a reaction score to the comment or photograph.

12. A system for collecting and disseminating scores from users associated with devices in communication with a central server, the system comprising:
a database including user information and associated tiles with each user, each tile being associated with an area of common interest;
a communications interface to broadcast scores with associated tiles to user devices;
a controller operable to:
receive requests to access a user account;
request a user to enter a score for at least one tile associated with an area of common interest, wherein the score relates to the user's feeling about the area of common interest;
receive the score from the user; and
send information allowing the display of scores relating to a plurality of tiles, each relating to an area of common interest, for display on a user device.

13. The system of claim 12, wherein the plurality of tiles each includes a tile name, a graphic and the score.

14. The system of claim 12, wherein the area of common interests includes at least one of a personal tile, a tile associated with another user and a group tile associated with a topic of interest.

15. The system of claim 12, wherein the request for an updated score is made after a predetermined period of time has elapsed where the user has not entered a score.

16. A device for participating in viewing data relating to user emotions, the device comprising:
a display;
a communication interface to receive data from a central database; and
a controller operable to:
display scores relating to the feeling of a user associated with an area of common interest via a tile representing the area of common interest on the display;
require a user to enter an updated score relating to the area of common interest; and
receive a score and allow the display of additional tiles relating to areas of common interest on the display.

17. The device of claim 16, wherein the plurality of tiles each includes a tile name, a graphic and the score.

18. The device of claim 16, wherein the area of common interests includes at least one of a personal tile, a tile associated with another user and a group tile associated with a topic of interest.

19. The device of claim 16, wherein the request for an updated score is made after a predetermined period of time has elapsed where the user has not entered a score.

20. The device of claim 16, wherein a plurality of tiles associated with areas of common interests is displayed, and wherein the order of tiles on the display may be changed based on a predetermined criteria.

21. The device of claim 16, wherein the controller is operable to add at least one other tile to the additional tiles based on a user request.

22. A non-transitory, machine readable medium having stored thereon instructions for collecting and displaying user scores on areas of interest, the stored instructions comprising machine executable code, which when executed by at least one machine processor, causes the machine processor to:
store a score from a user device relating to an area of interest to a user, wherein the score is associated with the user's feeling relating to the area of interest;
request an updated score from the user of the user device on the area of interest; and
on receiving the updated score, send scores relating to other areas of interest associated with the user for displaying a plurality of tiles on the user device.

23. The machine readable medium of claim 22, wherein the plurality of tiles each includes a tile name, a graphic and the score.

24. The machine readable medium of claim 22, wherein the area of common interests includes at least one of a personal tile, a tile associated with another user and a group tile associated with a topic of interest.

25. The machine readable medium of claim 22, wherein the request for an updated score is made after a predetermined period of time has elapsed where the user has not entered a score.

26. The machine readable medium of claim 22, wherein a plurality of tiles associated with areas of common interests is displayed, and wherein the order of tiles on the display may be changed based on a predetermined criteria.
